(19) United States
(12) Patent Application Publication
(10) Pub. No.: US 2026/0300480 A1
(43) Pub. Date: Oct. 1, 2026

(54) METHODS AND SYSTEMS FOR DETECTING ANOMALIES ACROSS DATA INFRASTRUCTURES

(71) Applicant: GravityFoundation, Corp., Niwot, CO (US)

(72) Inventors: Lucas Thelosen, Niwot, CO (US); Drew Gillson, Calgary (CA)

(21) Appl. No.: 19/461,603

(22) Filed: Jan. 27, 2026

Related U.S. Application Data
(60) Provisional application No. 63/753,743, filed on Feb. 4, 2025.

(51) Int. Cl. G06F 21/55; G06F 21/62

(52) U.S. Cl. CPC G06F 21/554; G06F 21/6218

(57) ABSTRACT

Various systems, methods, and computer program products for detecting anomalies across data infrastructure are provided. An example method includes causing a transmission of a request for data associated with an entity. The transmission is to at least one of a data platform or a data warehouse and includes credentials to access the data associated with the entity. The method also includes receiving the data associated with the entity from the at least one of the data platform or the data warehouse. The method further includes generating at least one insight associated with the entity based on the data associated with the entity. The at least one insight includes at least one recommended action for the entity. The method still further includes causing a rendering of the at least one insight to a user interface of a computing device.

### CROSS REFERENCE TO RELATED APPLICATIONS

This application claims priority to and the benefit of U.S. Provisional Application No. 63/753,743, filed Feb. 4, 2025, the contents of which is hereby incorporated by reference in its entirety for all purposes.

### TECHNICAL FIELD

The present disclosure generally relates to detecting anomalies across data infrastructures, and more particularly, to using artificial intelligence (AI) to detect anomalies, identify data trends, and/or provide recommendations across existing data infrastructures to provide continuous insights and suggested actions for operations optimizations.

### BACKGROUND

Current data analytics tools are limited in their ability to provide proactive, actionable insights without user intervention. Current tools often require significant manual input, such as query formulation, data interpretation, and/or the like. Despite advances in data visualization and machine learning, current tools still fail to address a critical need for autonomous, real-time analysis and action recommendation based on ongoing business trends. Prior tools that query data lack the ability to autonomously identify key business trends and prescribe specific actions without user prompts. The limitations of current tools create inefficiencies, particularly for businesses managing large volumes of data across complex operational environments.

### BRIEF SUMMARY

Various embodiments of the present disclosure provide for an AI-powered data analytics tool that identifies trends in data, detects anomalies in data, generates recommendations for optimization, and/or the like. For example, various embodiments may be used to autonomously investigate business metrics, identify trends and anomalies, and recommend actions to optimize operations and decision-making. Various embodiments are able to provide the functionality discussed herein using an agentic system, which is a system that is composed of multiple conversable agents. The agents are able to converse with each other and can be orchestrated centrally or self-organized in a decentralized manner. The system of the present disclosure integrates with various business intelligence platforms and data warehouses to deliver contextually relevant, actionable insights.

Using an agentic framework, the system interacts with existing business intelligence tools and data warehouses, providing continuous analysis and actionable insights. The system provides the ability to operate independently, using customer’s data warehouse credentials and internal knowledge base of over 250 business metrics to investigate data and deliver proactive recommendations. The system functions like an analyst, using AI, and offering a tool to optimize processes such as marketing spend, inventory management, customer engagement, and/or the like.

The agentic system of various embodiments, while currently integrated with platforms, is modular in nature. The modularity of the system allows the system to evolve in line with future advances in AI technologies, incorporating new machine learning models, data sources, and business objectives. The system is designed with the flexibility to handle emerging business intelligence platforms and novel data-processing methods, ensuring relevance in an ever-changing technological landscape. As such, the system allows for use with various different platforms.

Being interchangeable allows the system to solve a technological problem caused by advancements in computing. Namely, the system provides for more efficient computing without delay caused by advancements. For example, the time typically required to retrofit and/or create new systems in response to technological advancements is reduced or completely eliminated.

In some aspects, the techniques described herein relate to a system for detecting anomalies across data infrastructure, including: at least one non-transitory storage device; and at least one processing device coupled to the at least one non-transitory storage device, wherein the at least one processing device is configured to: cause a transmission of a request for data associated with an entity, wherein the transmission is to at least one of a data platform or a data warehouse and includes credentials to access the data associated with the entity, wherein the at least one of the data platform or the data warehouse includes data associated with the entity; receive the data associated with the entity from the at least one of the data platform or the data warehouse; based on the data associated with the entity, generate at least one insight associated with the entity, wherein the at least one insight includes at least one recommended action for the entity; and cause a rendering of the at least one insight to a user interface of a computing device.

In some aspects, the techniques described herein relate to a system, wherein the at least one processing device is configured to generate a summary of the at least one insight, wherein the summary is rendered to the user interface.

In some aspects, the techniques described herein relate to a system, wherein the at least one insight is associated with a detected anomaly or an identified trend.

In some aspects, the techniques described herein relate to a system, wherein the at least one insight is determined based on a previous plan associated with the entity, wherein the previous plan includes at least one previous insight.

In some aspects, the techniques described herein relate to a system, wherein the at least one of the data platform or the data warehouse is controlled by a third party entity, wherein the data associated with the entity is determined via the request.

In some aspects, the techniques described herein relate to a system, wherein the at least one processing device is configured to generate the at least one insight via one or more workflows.

In some aspects, the techniques described herein relate to a system, wherein a first agent device is in communication with a first data platform or data warehouse of the at least one of the data platform or the data warehouse and a second agent device is in communication with a second data platform or data warehouse of the at least one of the data platform or the data warehouse.

In some aspects, the techniques described herein relate to a system, wherein the first agent device determines a first insight of the at least one insight and the second agent device determines a second insight of the at least one insight.

In some aspects, the techniques described herein relate to a system, wherein the first agent device and the second agent device are distinct computing devices.

In some aspects, the techniques described herein relate to a system, wherein at least one of the first agent device or the second agent device is automated.

In some aspects, the techniques described herein relate to a method for detecting anomalies across data infrastructure, the method including: causing a transmission of a request for data associated with an entity, wherein the transmission is to at least one of a data platform or a data warehouse and includes credentials to access the data associated with the entity, wherein the at least one of the data platform or the data warehouse includes data associated with the entity; receiving the data associated with the entity from the at least one of the data platform or the data warehouse; based on the data associated with the entity, generating at least one insight associated with the entity, wherein the at least one insight includes at least one recommended action for the entity; and causing a rendering of the at least one insight to a user interface of a computing device.

In some aspects, the techniques described herein relate to a method, further including generating a summary of the at least one insight, wherein the summary is rendered to the user interface.

In some aspects, the techniques described herein relate to a method, wherein the at least one insight is associated with a detected anomaly or an identified trend.

In some aspects, the techniques described herein relate to a method, wherein the at least one insight is determined based on a previous plan associated with the entity, wherein the previous plan includes at least one previous insight.

In some aspects, the techniques described herein relate to a method, wherein the at least one of the data platform or the data warehouse is controlled by a third party entity, wherein the data associated with the entity is determined via the request.

In some aspects, the techniques described herein relate to a method, further including generating the at least one insight via one or more workflows.

In some aspects, the techniques described herein relate to a method, wherein a first agent device is in communication with a first data platform or data warehouse of the at least one of the data platform or the data warehouse and a second agent device is in communication with a second data platform or data warehouse of the at least one of the data platform or the data warehouse.

In some aspects, the techniques described herein relate to a method, wherein the first agent device determines a first insight of the at least one insight and the second agent device determines a second insight of the at least one insight.

In some aspects, the techniques described herein relate to a method, wherein the first agent device and the second agent device are distinct computing devices.

In some aspects, the techniques described herein relate to a method, wherein at least one of the first agent device or the second agent device is automated.

In some aspects, the techniques described herein relate to a computer program product for detecting anomalies across data infrastructure, the computer program product including at least one non-transitory computer-readable medium having one or more computer-readable program code portions embodied therein, the one or more computer-readable program code portions including at least one executable portion configured to: cause a transmission of a request for data associated with an entity, wherein the transmission is to at least one of a data platform or a data warehouse and includes credentials to access the data associated with the entity, wherein the at least one of the data platform or the data warehouse includes data associated with the entity; receive the data associated with the entity from the at least one of the data platform or the data warehouse; based on the data associated with the entity, generate at least one insight associated with the entity, wherein the at least one insight includes at least one recommended action for the entity; and cause a rendering of the at least one insight to a user interface of a computing device.

In some aspects, the techniques described herein relate to a computer program product, wherein the one or more computer-readable program code portions include at least one executable portion further configured to generate a summary of the at least one insight, wherein the summary is rendered to the user interface.

In some aspects, the techniques described herein relate to a computer program product, wherein the at least one insight is associated with a detected anomaly or an identified trend.

In some aspects, the techniques described herein relate to a computer program product, wherein the at least one insight is determined based on a previous plan associated with the entity, wherein the previous plan includes at least one previous insight.

In some aspects, the techniques described herein relate to a computer program product, wherein the at least one of the data platform or the data warehouse is controlled by a third party entity, wherein the data associated with the entity is determined via the request.

In some aspects, the techniques described herein relate to a computer program product, wherein the one or more computer-readable program code portions include at least one executable portion further configured to generate the at least one insight via one or more workflows.

In some aspects, the techniques described herein relate to a computer program product, wherein a first agent device is in communication with a first data platform or data warehouse of the at least one of the data platform or the data warehouse and a second agent device is in communication with a second data platform or data warehouse of the at least one of the data platform or the data warehouse.

In some aspects, the techniques described herein relate to a computer program product, wherein the first agent device determines a first insight of the at least one insight and the second agent device determines a second insight of the at least one insight.

In some aspects, the techniques described herein relate to a computer program product, wherein the first agent device and the second agent device are distinct computing devices.

In some aspects, the techniques described herein relate to a computer program product, wherein at least one of the first agent device or the second agent device is automated.

The above presents a simplified summary to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 provides a block diagram illustrating a system environment for detecting anomalies across data infrastructures, in accordance with various embodiments of the present disclosure;

FIG. 2 provides a block diagram illustrating the data analysis server(s) 151 of FIG. 1, in accordance with various embodiments of the present disclosure;

FIG. 3 provides a block diagram illustrating the computing device(s) 152 of FIG. 1, in accordance with various embodiments of the present disclosure;

FIG. 4 is a system diagram illustrating the interaction of the agent device(s) 155 of the data analysis system 175 with a data platform, in accordance with various embodiments of the present disclosure;

FIG. 5 is a flowchart illustrating generating automated responses to user inputs via a chat feature, in accordance with various embodiments of the present disclosure;

FIG. 6 illustrates an end-to-end process for various workflows carried out by the system, in accordance with various embodiments of the present disclosure;

FIG. 7 illustrates the various outputs shown in FIG. 6 organized for rendering to a user interface, in accordance with various embodiments of the present disclosure;

FIG. 8 illustrates system interactions and data generation within the system, in accordance with various embodiments of the present disclosure;

FIG. 9 illustrates a user interface with a dashboard with insights, in accordance with various embodiments of the present disclosure;

FIG. 10 illustrates a user interface with a integrations page that includes the various tools used for data analysis, in accordance with various embodiments of the present disclosure;

FIG. 11 illustrates a user interface with a data and documents page used to upload data and/or documents to be process using the system herein, in accordance with various embodiments of the present disclosure;

FIG. 12 illustrates a user interface with a configuration page 1200 including various information used by the system to determine the claims and/or insights discussed herein, in accordance with various embodiments of the present disclosure;

FIGS. 13A and 13B illustrate a user interface with an analysis planner page 1300 including multiple tasks (FIG. 13A) and specific details relating to a specific task (FIG. 13B), in accordance with various embodiments of the present disclosure;

FIG. 14 illustrates a user interface with an insights page 1400 including one or more insights generated using the system discussed herein, in accordance with various embodiments of the present disclosure;

FIG. 15 illustrates a user interface with an individual insight page 1500 with information relating to a specific insight, in accordance with various embodiments of the present disclosure; and

FIG. 16 illustrates a user interface with a chat page 1600 that includes a chat box for a user to engage with the automated system, in accordance with various embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

### I. Example Use Case

The present disclosure pertains to the fields of data analytics and artificial intelligence (AI), particularly in the area of autonomous data analysis, anomaly detection, and/or recommendation generation. For example, various embodiments of the present disclosure may be used to provide autonomous data analysis, anomaly detection, and/or recommendation generation in business intelligence environments. The AI-driven system proactively identifies trends and anomalies across existing data infrastructures to provide continuous insights and suggested actions for operations optimizations. However, systems that provide data analysis often quickly become obsolete due to advancements in computing. The system architecture of various embodiments is designed to be flexible and scalable. The system architecture allows for future integration with more advanced AI models and expanded functionalities in areas such as predictive analytics, adaptive learning systems, cross-industry applications, and/or the like.

Current business intelligence (BI) tools are limited in their ability to provide proactive, actionable insights without user intervention. Current tools often require significant manual input, such as query formulation, data interpretation, and/or the like. Despite advances in data visualization and machine learning, current tools still fail to address a critical need for autonomous, real-time analysis and action recommendation based on ongoing business trends. Prior tools that query data lack the ability to autonomously identify key business trends and prescribe specific actions without user prompts. The limitations of current tools create inefficiencies, particularly for businesses managing large volumes of data across complex operational environments.

Various embodiments of the present disclosure addresses the issues of current data analysis tools by introducing an AI-driven system that autonomously monitors, investigates, and generates insights based on predefined business metrics. The features of various embodiments eliminate the need for manual queries and allows for timely, data-driven decision-making that enhances operational efficiency. The system architecture of various embodiments is designed to overcome these present-day limitations, while also being adapted to the evolving needs of future business intelligence environments. As data complexity grows, the system architecture of various embodiments will be capable of integrating new machine learning models and handling larger data sets with greater efficiency.

Various embodiments of the present disclosure provided for an AI-powered data analytics tool that identifies trends in data, detects anomalies in data, generate recommendations for optimization, and/or the like. For example, various embodiments may be used to autonomously investigate business metrics, identify trends and anomalies, and recommend actions to optimize operations and decision-making. Various embodiments are able to provide the functionality discussed herein using an agentic system, which is a system that is composed of multiple conversable agents. The agents are able to converse with each other and can be orchestrated centrally or self-organized in a decentralized manner. The system of present disclosure integrates with various business intelligence platforms and data warehouses, including Google Cloud’s BigQuery and Looker, to deliver contextually relevant, actionable insights.

Using an agentic framework, the system interacts with existing business intelligence tools (such as Looker) and data warehouses (like Google BigQuery), providing continuous analysis and actionable insights. An insight (or actionable insight) may be information based on the data and other data (e.g., an insight may be comparison of the number of units sold this month versus this month one year ago). The system provides the ability to operate independently, using customer’s data warehouse credentials and an internal knowledge base of over 250 business metrics to investigate data and deliver proactive recommendations. The system functions like an analyst, using AI, offering a tool to optimize processes such as marketing spend, inventory management, customer engagement, and/or the like.

The agentic system of various embodiments, while currently integrated with platforms such as Looker and BigQuery, is modular in nature. The modularity of the system allows the system to evolve in line with future advances in AI technologies, incorporating new machine learning models, data sources, and business objectives. The system is designed with the flexibility to handle emerging business intelligence platforms and novel data-processing methods, ensuring relevance in an ever-changing technological landscape. As such, the system allows for use with various different platforms.

The system being interchangeable allows for the system to solve a technological problem caused by advancements in computing. Namely, the system provides for more efficient computing without delay caused by advancements. For example, the time typically required to retrofit and/or create new systems in response to technological advancements is reduced or completely eliminated.

Various embodiments of the present disclosure provide a model-agnostic multi-agent autonomous AI system designed to operate independently within data environments, such as business environments. The system architecture supports various proprietary and open-source AI models, which the agents use for inference, reasoning, and decision-making. However, no specific model is required for the system to function, allowing for flexibility in integrating future AI technologies. While the system may be used with various different AI models, example embodiments may use a model best suited for a given use case. For example, a generic AI model may use Claude 3.5 Sonnet 10-22, while a vision based used case may use a Gemini 1.5 Pro 002 AI model. Other example AI models that may be used include GPT-4.0, Gemini 2.0 Flash Exp, and Llama 3.1. In various embodiments, the system may use any AI model that provide the real world reasoning. As such, the AI model may be updated or changed to improve the real world reasoning.

The system of various embodiments uses an agentic workflow. The agentic workflow involves specialized agents that collaborate to continuously monitor data streams, detect anomalies, and identify trends. Each agent is responsible for a specific analysis type (e.g., supply chain optimization, marketing performance, etc.) and works together to provide actionable insights. The distributed system allows for task decomposition, enabling agents to break down complex tasks and complete them linearly to optimize performance.

The agent devices (or agents) of the present disclosure may employ a narrative framing approach, which treats each agent device’s inputs and outputs as having inherent narrative properties. The narrative framing method ensures that agents not only process data but also generate outputs in a format that is meaningful and contextualized (e.g., such as outputs that are appropriate for business users). Narrative Framing allows the system to manage known issues such as hallucinations (incorrect outputs common in language models) and supports efficient prompt design. By framing outputs narratively, the agents effectively translate complex data into usable insights that are easily understandable and actionable for colleagues.

The system of various embodiments uses pseudo personhood, wherein the agents operate with gestalt properties that mimic the behavior of an autonomous person. The agents are able to interact with human colleagues in ways that feel natural and collaborative. The agents’ role is to assist as if the agents were human participants, capable of engaging in ongoing discussions, making suggestions, and contributing to decision-making. The internal collaboration and specialization of agents help the system resist emotional manipulation and prompt injection and manipulation attacks. These are essential properties for autonomous interaction with internal staff. The agents of various embodiments operate independently, simulating human-like behaviors, but are optimized for executing data-driven tasks and processes. As such, the agents may be used in entirely autonomous environments (e.g., multiple agent devices are in operation) and/or in hybrid environments (e.g., an environment in which agent devices and human operators are also included). As such, the system may be adaptable to different use cases.

The autonomous operation of agent devices allow the agent devices to function as automated users within an organization. The automated user(s) (e.g., agent device(s)) can engage with human users, much like a regular user, to provide insights, answer questions, and recommend actions. The system enables a continuous two-way interaction, where agent devices learn from automated and/or non-automated user feedback and refine recommendations over time. Through interaction, the agent devices develop a deeper understanding of organizational goals and can become progressively more effective in driving business operations.

Each of the agent devices may have an Agentic Personal Memory (APM) system, allowing each agent device to retain context across interactions with users. The APM system enables the agent devices to continuously learn and adapt, which improves the system performance over time. The APM system allows for the agent devices to recall past interactions and insights, helping to create a more personalized and contextually relevant experience. The memory feature supports the system’s autonomous nature, allowing agent devices to operate without constant human oversight while still delivering results that align with the business’s evolving needs. Additionally, the agent devices may be used in conjunction with human agents without requiring human oversight of the agent devices.

The agent device(s) are structured to follow a hierarchical task decomposition methodology, where larger tasks are fractionally broken down into smaller, manageable tasks. As such, each agent device is able to focus on narrow and achievable tasks, preventing the system from becoming overwhelmed by too much information or losing track of the primary objective. The decomposition process also helps manage the context window, ensuring that agent devices remain effective even when handling complex and multi-layered analyses. The approach of various embodiments prevents and/or mitigates common reasoning flaws in large language models (LLMs).

The agent devices have access to a methods library. Access to the methods library may be via a network (e.g., agent device may be connected to a network and receive the methods library via the network) and/or the methods library may be locally stored (e.g., the agent device(s) may store the methods library locally). The methods library contains predefined processes, tools, and routines that the agents can call upon to perform specific tasks. The methods library may be curated by experts in the field in a level of detail not necessarily accessible on the open internet ensuring that the LLMs have the distilled skill set of a genuine industry expert. Example methods included in the methods library include cohort analysts, dataset comparison, simple query analysis, and/or the like. The methods library may be updated over time to include other methods. The methods library enables the agent device(s) to autonomously determine which approach to use based on the data they are analyzing and the goals the agent device(s) are tasked with achieving.

Additional data libraries may also be accessible for the agent device(s). The methods library may also be different for different agent device(s). For example, the methods library may be based on the type of data analysis conducted by a given agent device.

The agent device(s) may also have Agentic Command Line Tooling, which allows the agent device(s) to interact with existing CLI or API-driven services in a text-based manner that is easily understood by large language models (LLMs). Unlike traditional function calling, the agentic command line tooling approach minimizes complexity and token cost, leveraging the natural ability of LLMs to interpret and manage CLI commands. Tested on multiple models, including Gemini 1.5, Claude Sonnet 3.5, and GPT-4.0, the tooling enables at-inference learning, allowing agents to adapt to new tools and services dynamically.

By utilizing the Agentic Command Line, the agent device(s) can operate seamlessly with various enterprise systems without requiring extensive setup or specific instructions. The system can dynamically adapt to new tools without fine-tuning and/or changes to the application, allowing for efficient integration without complex, time-consuming training processes. Planned dynamic memory will further enhance the agent device capability, allowing agent devices to remember past command line interactions and use this history to optimize future tasks.

The learning capabilities of the system are primarily driven by the APM system and continuous interaction with users. Each agent device(s) retains context from previous engagements, allowing the agent device(s) to refine recommendations and actions over time. The iterative learning process involves analyzing feedback from user responses and actions taken in relation to the agent device suggestions. Through the feedback loops, the system continuously improves the decision-making algorithms, better aligning future recommendations with the evolving objectives of the business. Additionally, the agent device(s) autonomously adjust the internal logic based on patterns observed in the organization’s data and user preferences, enabling the system to adapt without requiring manual retraining.

An example use case of various embodiments may include comparing forecast to actual results. For example, the system may compare the data in a forward projection data source against the actual data generated after the fact. In various embodiments, the comparison may be used to train the system for future recommendations. In an example in which the system is used in a shipping use case, the raw data that may be retrieved is associated with a volume of goods shipped by a producer. The actual volume of goods shipped may be compared to a predicted volume of goods shipped to determine performance. The comparison data may be used to update information (e.g., statistics, spreadsheets, etc.) relating to the raw data (e.g., for use in future predictions, anomaly detection, etc.). In various embodiments, the comparison may be used to determine the accuracy of a prediction (e.g., a prediction either manually or automatically made).

Another example use case includes allowing users to visually identify any issues with the system. For example, a user may find and observe (using a vision model) the BI Tool dashboards that meet a given criteria for the request (e.g., a sales dashboard). The user may visually inspect each tile within the dashboard and may identify any issues with misformatting and/or incorrect data. Additionally, the system may be capable of the identifying issues (e.g., the system may have an expected visual or value for a tile and therefore can compare the expected visual or value against the actual visual or value to determine any issues). The system may also be able to investigate underlying queries to diagnose any issues. The system may provide an error notification with information relating to the issue. For example, the system may generate an error notification in an instance in which a potential issue is found (e.g., allowing a user to investigate) and/or the system may generate an error notification in an instance in which the system has completed an investigation.

Various embodiments of the system may consider various different analyses during operation. Example analyses include, but are not limited to fundamental calculation (e.g., data Validation, Count Operations, Sum Operations, Basic Rate and Percentage Calculations, Central Tendency Measures, Simple Weighted Averages, Ranges and Spread Measures, Basic Data Grouping, Distribution Characteristics, Basic Time-Based Aggregation, Basic Change Calculations), comparative analytics (e.g., Basic Data Distribution Understanding, Selection of Appropriate Measures of Central Tendency, Basic Data Quality: Percentiles, IQR & Basic Outlier Detection, Dynamic Range Bucketing, Basic Segmentation, Multi-Dimensional Grouping, Cross-Group Comparisons, Basic Trend Analysis, Correlation Analysis, Performance Metrics, Quality Assurance Metrics), and/or the like.

### II. Example Embodiment

In an example embodiment of the present disclosure, the system may obtain user credentials to access a platform (e.g., an organization’s data warehouse platform, such as Looker or PowerBI). The agent device(s) are capable of understanding the organization’s objectives. The system will connect to the platform (e.g., data warehouse) and leverage third-party data sources to identify trends or anomalies relevant to the organization’s operations.

The system autonomously analyzes the retrieved data and generates findings based on the retrieved data (e.g., identifying trends and/or anomalies, determining optimization actions, and/or the like). The system may present the findings from the agent device(s), along with recommended actions, through a user interface, operating without the need for ongoing manual oversight. The process of anomaly detection, reporting findings, and recommending actions is continually iterated, allowing the system to adapt to new data over time until the system is turned off Additional agent device(s) may analyze multiple different data sets.

The system may understand the objectives of an entity via one or more channels. For example, an entity may have provided explicit objectives (e.g., the system may have received one or more objectives for the entity and the objective(s) may be stored on the system). In various embodiments, a request may include objectives (e.g., a user may provide objectives explicitly or implicitly when making a request for analysis). In such an example, the system or a user may analyze the request and consider the underlying motivation and objective of the request in context of any other provided information. The objectives may be determined via analysis of the data associated with an entity. For example, the system may perform meta-analysis on user usage associated with the entity to determine which fields, data, dashboards, etc. have the most focus in the entity.

The system may also interact with users within the entity (e.g., via a portal), learning from the interactions to gain a deeper understanding of the evolving needs and objectives of the entity. The ongoing engagement enables the system to improve insights and suggestions.

The system is capable of operating independently, requiring minimal human intervention. The system integrates with various business data platforms and continuously learns from user interactions, ensuring the ability of the system to autonomously refine the processes. By engaging with different users within the organization, the system provides insights and recommendations.

Currently, the system is designed to integrate with business data sources such as BigQuery, Looker, and PowerBI. However, the modular architecture of the system (e.g., the distinct agent devices) allows the system to easily adapt to future data platforms, machine learning models, and AI technologies. The flexibility of the system allows for the system to evolve with advancements in AI, while maintaining the core functionalities and scalable operations.

The system of various embodiments is designed with flexibility and adaptability in mind, allowing the system to be configured to meet a wide variety of business and technical needs. One of the key aspects of the present disclosure is the modular architecture of the system, which enables seamless integration with different platforms, data sources, and machine learning models, thus broadening the applicability across various industries and operational environments.

Various embodiments of the system may include different machine learning models, which enhance and/or otherwise modify data analysis capabilities of the system. For example, while the current implementation may use models such as OpenAI’s GPT or Google’s Gemini for natural language processing and data analysis, the system is designed to easily incorporate other machine learning frameworks. For example, the system may integrate with reinforcement learning models for decision-making processes or use deep learning models specialized for specific tasks, such as image recognition or advanced pattern identification.

Additionally, the system could be adapted to incorporate industry-specific models. For instance, in the finance sector, the system may leverage predictive modeling techniques for fraud detection or financial forecasting. In healthcare, the system may employ machine learning models tuned for patient diagnosis and treatment recommendation systems. The agnostic nature of the system allows for the system to be used across different industries and different use cases.

The flexible architecture of the system allows for integration with a wide range of data platforms and business intelligence tools. The system is designed to adapt to various data environments, ensuring compatibility with both cloud-based platforms and on premise solutions.

In addition to traditional data warehouses, the system may be configured to work with modern data platforms such as Snowflake and dbt Labs, as well as emerging technologies that organizations may adopt in the future. This adaptability ensures the system may be effectively used across diverse technical ecosystems, whether an organization uses standard SQL databases, real-time data streams, or specialized industry-specific platforms.

The flexibility of the system allows for entities (e.g., businesses) to integrate the system into existing infrastructure with minimal friction, ensuring that the system can handle a variety of data sources and formats to support data-driven decision-making in virtually any industry.

The core functionality of the system (e.g., anomaly detection, data analysis, and recommendations) may be extended to support various use cases across multiple industries. While various embodiments of the present disclosure currently focuses on business intelligence and data analytics, the system may be used for IT operations (e.g., the system may be used to analyze logs, monitor system performance, detect anomalies in real-time, and optimize IT infrastructure), AI operations (e.g., the system may manage and monitor machine learning model deployments, automatically detecting issues in model performance or data drift and suggesting optimization strategies), mainframe systems (e.g., in legacy environments, the system may integrate with mainframe systems to analyze operational data, detect inefficiencies, and optimize processes), predictive maintenance (e.g., for a manufacturing use case, the system may predict equipment failures or maintenance needs by analyzing sensor data, helping to reduce downtime and increase operational efficiency), customer behavior analysis (e.g., for an e-commerce use case, the system may analyze customer data to detect trends, recommend personalized offers, and predict future purchasing behaviors), and/or the like.

The modularity of the system allows for custom configurations based on the specific requirements for an entity. The analysis modules of the system may be adjusted to focus on various types of data, such as customer data, financial transactions, supply chain data, or marketing analytics. The level of automation in anomaly detection and recommendation processes can be tailored, ranging from fully autonomous operation to user-guided processes where human experts play a more interactive role.

As AI technologies and business needs continue to evolve, the system design ensures that the system remains adaptable to future advancements. Its architecture supports integration with new AI models, tools, and platforms as they emerge, providing a flexible, scalable solution for organizations across different sectors. This adaptability allows the system to stay relevant in industries where rapid technological change is a factor.

The embodiments shown and/or discussed below in reference to the figures may carry out the operations discussed herein. For example, the operations discussed above may be carried out by the data analysis system 175 (e.g., the data analysis server(s) 151 and/or the agent device(s) 155) and/or the computing device(s) 152.

### III. With Reference to the FIGs.

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to using artificial intelligence (AI) to detect anomalies, identify data trends, and/or provide recommendations across data infrastructures. In the following description, for purposes of explanation, numerous specific details are set forth to provide a thorough understanding of the present disclosure. It will be evident, however, to one skilled in the art that the present disclosure may be practiced without these specific details and/or with any combination of these details.

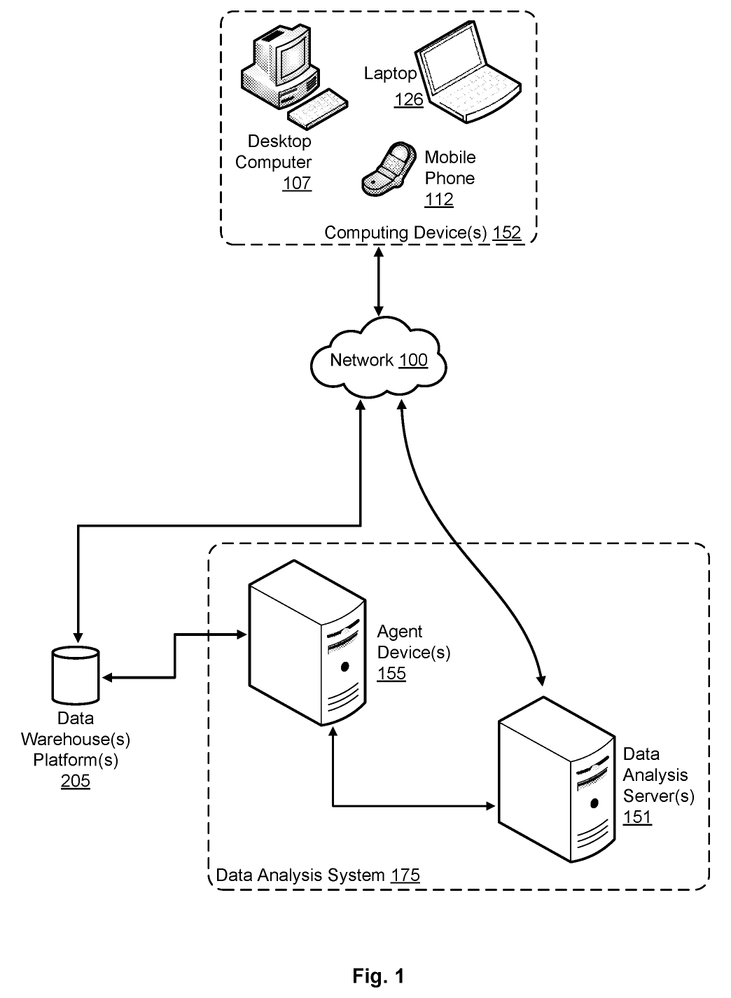

Referring now to FIG. 1, a block diagram illustrating a system environment (“system”) for detecting anomalies, identifying data trends, and/or providing recommendations across data infrastructures, in accordance with various embodiments is provided. While various embodiments discussed herein relate to data analysis for business use cases, any number of different data types may be processed, stored, and used using the operations herein.

The system includes computing device(s) 152 and a data analysis system 175 connected to a network 100. As shown, the computing device(s) 152 (e.g., desktop computer 107, mobile phone 112, laptop 126, and/or the like) may be associated with users (e.g., employees of the entity) are in communication with network 100. The data analysis system 175 is also in communication with the network 100.

The data analysis system 175 includes one or more data analysis servers 151 and one or more agent device(s) 155. In various embodiments, the data analysis server(s) 151 may be made of multiple servers. The agent device(s) 155 may be part of the data analysis server(s) 151 and/or separate from the data analysis server(s) 151. Each agent device may be task oriented, such that the agent device receives one or more tasks to accomplish, usually relating to data analysis. As such, the agent device(s) 155 may retrieve data (e.g., from data warehouse(s)/platform(s) 205). The agent device(s) 155 may each be distinct (e.g., each agent device may be a distinct device). In such an embodiment, the agent device(s) 155 may include a communication interface to communicate with the data analysis server(s) 151 and/or the network 100. In various embodiments, multiple agent device may be the same device (e.g., a computing device may be capable of carrying out the operations of multiple agent devices).

In various embodiments, the data warehouse(s)/platform(s) may be part of the data analysis system 175 (e.g., at least a portion of the data warehouse(s)/platform(s) 205 may be stored on the memory device(s) 268 of the data analysis server(s) 151 and/or stored on a memory device of an agent device). Additionally or alternatively, at least a portion of the data warehouse(s)/platform(s) 205 may be stored remote from the data analysis system 175. For example, a third party entity may control one or more data warehouses and/or platforms, and agent device(s) may obtain access to the data within using credentials or the like. One or more of the data warehouse(s)/platform(s) 205 may be in communication with the network 100.

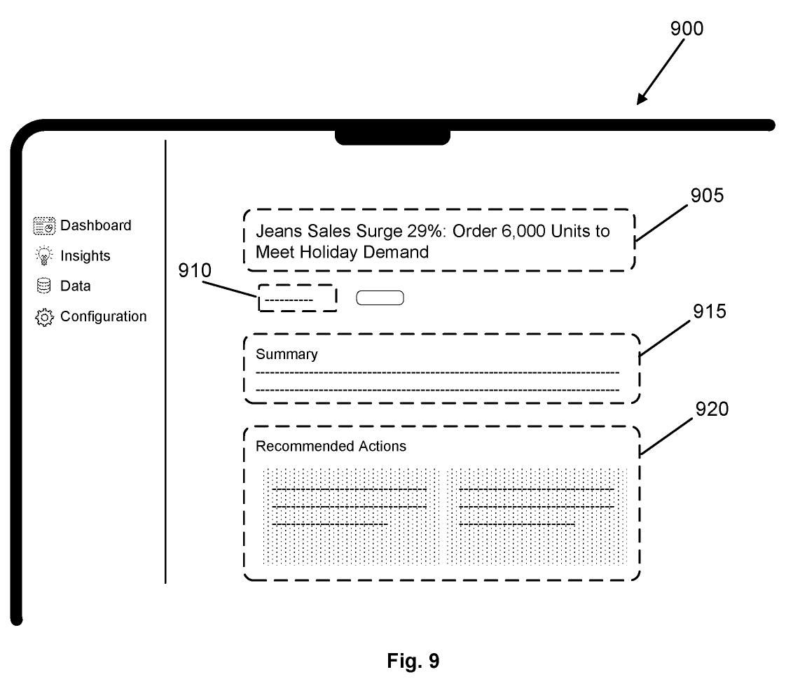

The computing device(s) 152 may be associated with a user (e.g., an employee of the entity). The computing device(s) 152 may be capable of displaying the various user interfaces discussed herein (e.g., FIGS. 9-16). The computing device(s) 152 may also allow for human interactions. For example, in an instance in which agent device(s) 155 and human agents are used, the human agent(s) may use computing device(s) 152. The computing device(s) 152 may be connected to the network 100.

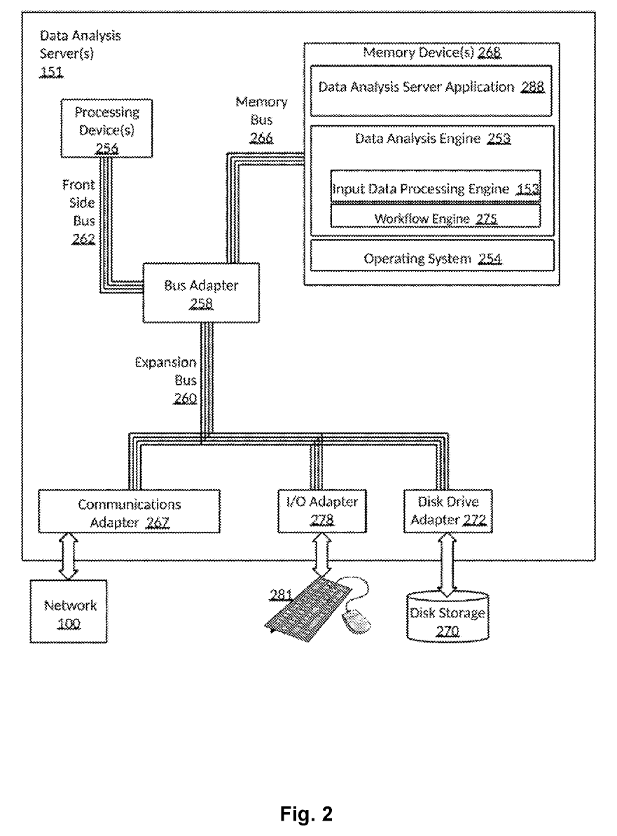

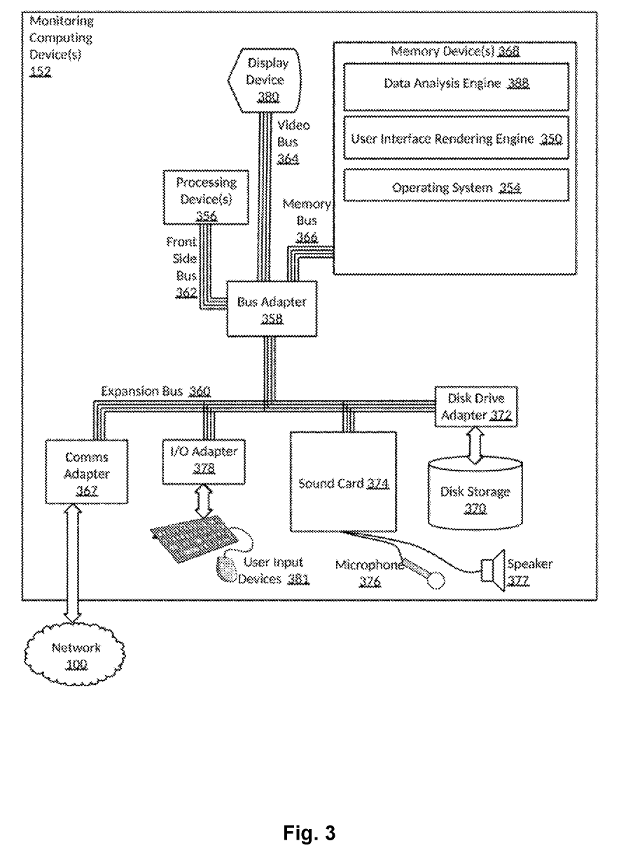

Referring now to FIG. 2, a block diagram illustrating the data analysis server(s) 151 of FIG. 1, in accordance with various embodiments is provided. FIG. 2 is merely illustrative an example data analysis server(s) 151. In various embodiments, the data analysis server(s) 151 may share components with the computing device(s) 152 (e.g., the data analysis server(s) 151 may use at least a portion of the processing device(s) 356 of the computing device(s) 152 shown in FIG. 3). The data analysis server(s) 151 may be comprised of one or more servers. In various embodiments, the data analysis server(s) 151 may be capable of processing user inputs via a computing device(s) 152 and generating user interfaces to be rendered to computing device(s) 152. The agent device(s) 155 shown in FIG. 1 may use any of the components of the data analysis server(s) 151. For example, the agent device(s) 155 may be part of the data analysis server(s) 151 (e.g., the operations discussed in reference to the agent device(s) 155 may be carried out by the data analysis server(s) 151). Alternatively, the agent device(s) 155 may be independent of the data analysis server(s), but includes any of the components, such as processing device(s), memory device(s), and/or the like.

The data analysis server(s) 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, and the communication adapter 267, I/O adapter 278, disk drive adapter 272, and/or other interfaces may be attached via expansion BUS 260).

It should be understood that the memory device(s) 268 may include one or more databases or other data structures/repositories. The memory device(s) 268 also includes computer-executable program code that instructs the processing device(s) 256 to operate the network communication interface (e.g., communication adapter 267) to perform certain communication functions of the system described herein. For example, in one embodiment of the data analysis server(s) 151, the memory device(s) 268 includes, but is not limited to, a data analysis server application 288, a data analysis engine 253, and an operating system 254. The data analysis engine 253 may also include an input data processing engine 153, a workflow engine 275, and/or the like with instructions to carry out the processes discussed herein. The workflow engine 275 may include the necessary functionality to carry out the workflow operations discussed herein (e.g., receive inputs and generate outputs).

The data analysis engine 253 may have various other components that are capable of processing user inputs via a computing device(s) 152. The memory device(s) 268 may store, among other things, insights and/or claims, raw data sets, processing instructions, and/or the like. Additionally, the data analysis engine 253 may be capable of processing data in the various forms discussed herein (e.g., as discussed in reference to the agent device(s)).

Some embodiments of the data analysis server(s) 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the data analysis server(s) 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the data analysis server(s) 151 may be configured to operate with one or more air interface standards, communication protocols, modulation types, and access types. By way of illustration, the data analysis server(s) 151 may be configured to operate in accordance with any of a number of first, second, third, fourth, and/or fifth-generation communication protocols and/or the like. In various embodiments, the data analysis server(s) 151 may also be connected via other connection methods to one or more components of the data analysis system 175.

The memory device(s) 268 is connected to and editable by the processing device(s) 256. The memory device(s) 268 may store, among other things, logic used to orchestrate the functioning of the data analysis server(s) 151, including logic implementing the functions described above, and various databases of information.

Note that the control logic can be implemented in software, hardware, firmware or any combination thereof. In the example data analysis server(s) 151 shown in FIG. 2, the control logic is implemented in software and stored in the memory device(s) 268. When implemented in software, the control logic can be stored and transported on any computer-readable medium for use by or in connection with an instruction execution apparatus that can fetch and execute instructions, such as the processing device(s) 256.

Relatedly, in some embodiments the control logic may be part of a software application running on the data analysis server(s) 151. For example, the control logic may be part of a software application (“app”) of a healthcare provider.

The I/O adapter 278, which allow the data analysis server(s) 151 to receive data from a user such as a system administrator, may include any of a number of devices allowing the data analysis server(s) 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the data analysis server(s) 151, such as cloud storage (e.g., transmitted via the communication adapter 267).

Referring now to FIG. 3, a block diagram illustrating the computing device(s) 152 of FIG. 1, in accordance with various embodiments is provided. FIG. 3 is merely illustrative an example computing device(s) 152. Various types of computing device(s) 152 may be used or otherwise contemplated for the system. The computing device(s) 152 may include components to allow the computing device(s) 152 to assist or otherwise carry out the operations of the data analysis server(s) 151.

Example computing devices include desktop computers 107, mobile devices, such as mobile phones 112, tablets, smart watches, etc., laptops 126, and/or the like. As such, the computing device(s) 152 may be any device that is capable of performing the operations discussed herein. For example, a mobile phone may include communication interfaces to communication with mobile networks and local area networks (e.g., via Wi-Fi).

The computing device(s) 152 of FIG. 3 includes one or more processing devices 356, one or more memory devices 368, a display device 380, a communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, the display device 380 may be attached via a video BUS 364, and the communication adapter 367, I/O adapter 378, disk drive adapter 372, and/or other interfaces may be attached via expansion BUS 360).

It should be understood that the memory device(s) 368 may include one or more databases or other data structures/repositories. The memory device(s) 368 also includes computer-executable program code that instructs the processing device(s) 356 to operate the network communication interface (e.g., communication adapter 367) to perform certain communication functions of the system described herein. The memory device(s) 368 may include a user interface rendering engine 350 with instructions on generating and/or rendering user interfaces to allow the computing device(s) 152 to interact via the network. The memory device(s) 368 also includes a data analysis engine 388 that includes instructions on reformatting data received from a data analysis system 175 as discussed herein to be rendered and/or otherwise processed by the computing device(s) 152. The memory device(s) 368 may also include the operating system 354 of the computing device(s) 152. Example user interfaces renderings generated and/or rendered via the computing device(s) 152 are shown in FIGS. 9-16.

Some embodiments of the computing device(s) 152 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols and/or the like).

The I/O adapter 378, which allow the computing device(s) 152 to receive data from a user such as a system administrator, may include any of a number of devices allowing the computing device(s) 152 to receive data from the user, such as a keypad, keyboard 381, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the computing device(s) 152, such as cloud storage (e.g., transmitted via the communication adapter 367).

As described above, the computing device(s) 152 has a user interface that is, like other user interfaces described herein, rendered via the display device 380. The display device 380 include a display (e.g., a liquid crystal display or the like) and/or a speaker or other audio device, which are operatively coupled to the processing device(s) 356. As such, the data packets and/or information obtained from data packets discussed herein may be provided to the computing device(s) 152 via the display device 380 (e.g., visually via the user interface). In various embodiments, the display device 380 may be in communication with a sound card 374 (e.g., attached to a microphone 376 and/or a speaker 377 (e.g., the speaker 377 may be part of the display device 380 or standalone)).

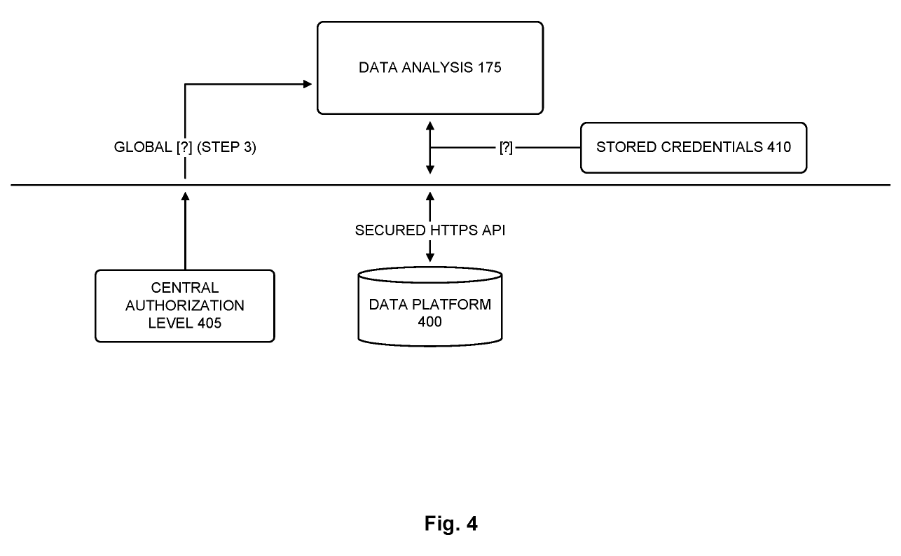

Referring now to FIG. 4, an example system diagram is shown illustrating the interaction of the agent device(s) 155 of the data analysis system 175 (shown in FIG. 1) with a data platform (e.g., data warehouse(s)/platform(s) 205). An example data platform is Looker Studio by Google. The system may be used with various different data platforms and/or warehouses. As shown, the data analysis system 175 (e.g., an agent device of the data analysis system 175) may access a data platform 400 of the data warehouse(s)/platform(s) 205 shown in FIG. 1. The system may use a central authorization layer 405, such as Google’s Identity-Aware Proxy to provide access to the data platform and/or data warehouse (e.g., data platform 400).

The agent device(s) 155 of the data analysis system 175 are capable of accessing the data platform 400 (e.g., via stored credentials 410 from the central authorization layer 405). The stored credentials 410 may be stored using various different credential managers. The agent device(s) may be capable of retrieving data from the data platform 400. The data platform 400 controls the access of the agent device and the agent device is not capable of getting data that was not requested and approved. As such, the agent device may obtain the data from the data platform 400 without direct database access and/or without any changes to the data platform 400. The operations of FIG. 4 may be repeated across different data platform(s) and/or data warehouses.

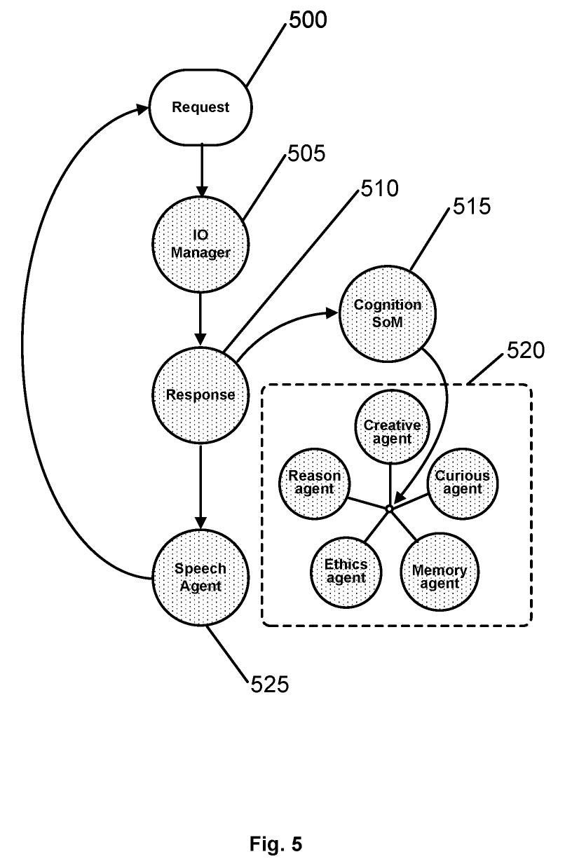

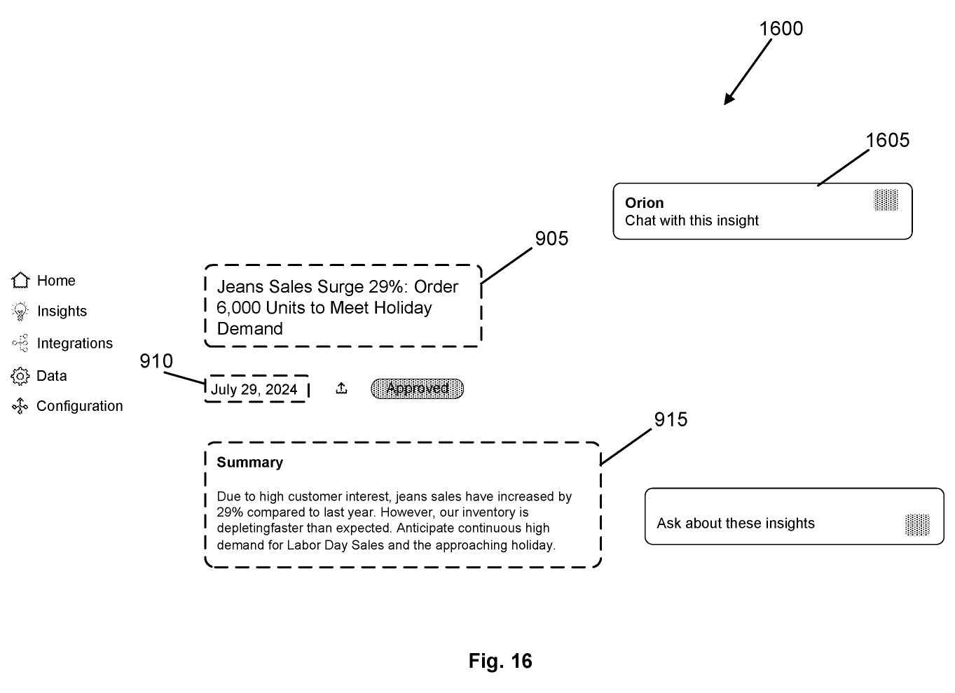

Referring now to FIG. 5, a flowchart is provided illustrating the operations of providing automated responses to user inputs (e.g., via a chat function, such as the chat shown in FIG. 16). A request 500 (e.g., a user input) with a request for information or a question is received. An IO manager 505 processes the request and determines the response content at response 510. The response 510 may be determined using a cognition self-recognizing map 515, which uses one or more agent devices 520 (e.g., creative agent, reason agent, curious agent, ethics agent, memory agent, etc.). The agent device(s) 520, alone or in combination provide a response to the user input. The speech agent 525 may take the generated response and format the response for provision to the computing device associated with the user (e.g., conversational format).

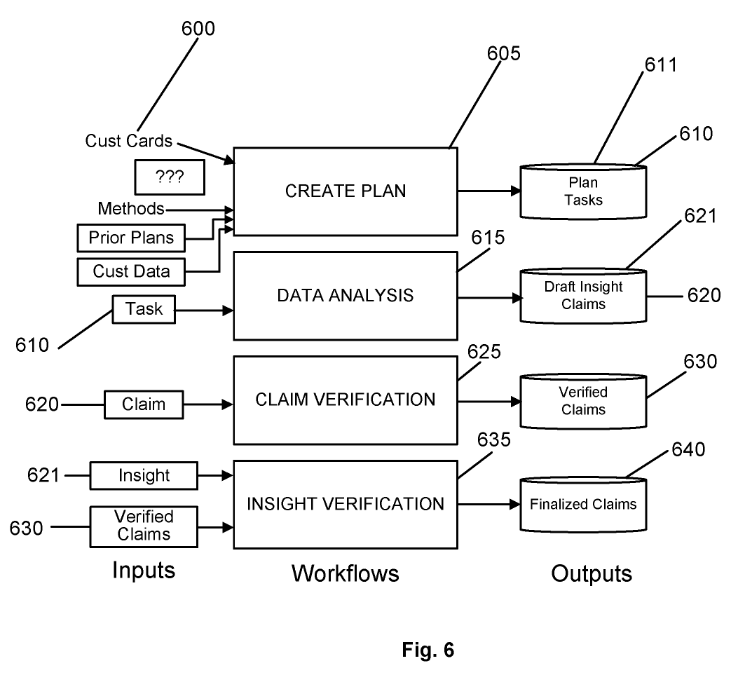

Referring now to FIG. 6, an example end-to-end process of the system is provided. The system may be capable of carrying out the various workflows discussed herein. For example, the system (e.g., the data analysis system 175) may be capable of completing various workflows (e.g., processes), such as create plan workflow 605, data analysis workflow 615, claim verification workflow 625, and/or insight verification workflow 635. Each workflow may have an input and an output. The system may receive an input and generate the output using the given workflow (e.g., the workflow may include one or more instructions for generating the output). In some instances, the output of a first workflow may be used as an input for another workflow. For example, the task 610 (output of the create plan workflow 605) may be used as an input for the data analysis workflow 615, the claim(s) 620 (output of the data analysis workflow 615) may be used as an input for the claim verification workflow 625, and the verified claim(s) 630 (output of the claim verification workflow 625) and/or the insight(s) 621 (output of the data analysis workflow 615) may be used as an input for the insight verification workflow 635. The finalized insight(s) 640 (the output of the insight verification workflow 635) may be used as an input for other workflow(s) in various embodiments. In various embodiments, the inputs may be obtained for other sources (e.g., not from the output of other workflows). For example, the system may receive a task 610 without using the create plan workflow 605.

Referring to the create plan workflow 605, example inputs 600 includes customized configurations, methods (e.g., from the methods library), prior plans (e.g., generated from previous operations of the systems and/or independently by a user), and/or customized data. To generate a plan, the system may search the inputs in order to determine the operations to perform (e.g., the analysis required based on the content of the data). Based on the create plan workflow 605, task(s) 610 and/or plan(s) 611 may be generated.

Referring to the data analysis workflow 615, example inputs include tasks (e.g., such as task(s) 610 outputted from the create plan workflow 605). In various embodiments, one or more of the task(s) may be obtained independent of the create plan workflow 605 (e.g., the task(s) may be provided to the system by a third party). The data analysis workflow 615 may process the data received from agent device(s) discussed herein to determine claim(s) 620 and/or insight(s) 621. A claim may be an analysis of the data (e.g. a claim may be that X number of shirts were sold during a given period). An insight may be information based on the data and other data (e.g., an insight may be comparison of the number of units sold this month versus this month one year ago).

Referring to the claim verification workflow 625, example inputs include claims. For example, the claim(s) 620 may be used as an input for the claim verification workflow 625. The claim verification workflow 625 may include instructions for verifying claims. For example, the claim verification workflow 625 may include additional analysis of the data, analysis of additional data, retrieving relating data for verification, and/or the like. For example, the claim verification workflow 625 may include comparing the number of units sold to the amount of revenue to determine whether the numbers match one another. Based on the claim verification workflow 625, the system determines whether the claim input is accurate (e.g., thereby generating verified claim(s) 630).

Referring to the insight verification workflow 635, example inputs include insight(s) and/or verified claims(s). For example the inputs may include insight(s) 621 and/or the verified claim(s) 630. In various embodiments, the verified claim(s) may be used to analyze the insight(s) for verification. For example, the verified claim(s) may be compared to the insight(s) to determine whether the insight(s) (e.g., a prediction or recommendation) matches the verified claims. For example, an insight may be that more units need to be ordered and the insight verification workflow 635 may determine whether the verified claim(s) support the insight (e.g., the verified claims may indicate that demand is up year over year and therefore the insight of needing more units is accurate. The output of the insight verification workflow 635 is the finalized insight(s) 640. In various embodiments, one or more workflows may be combined.

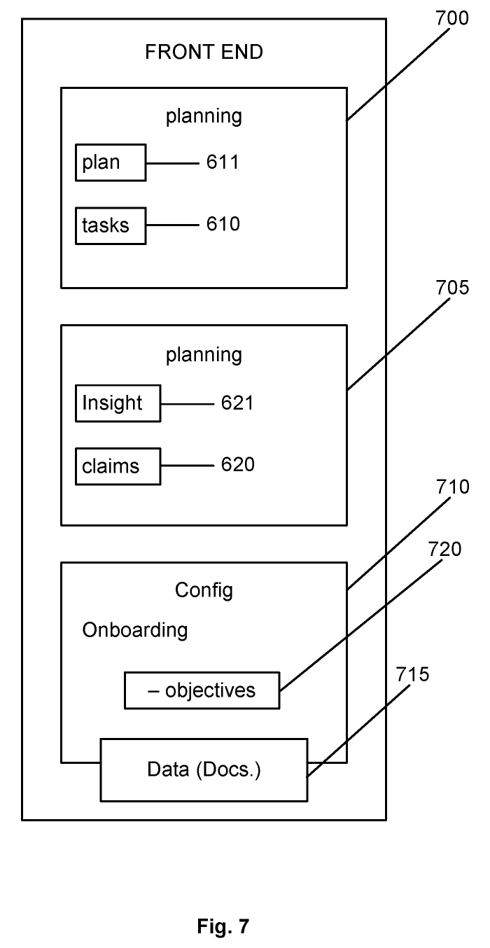

Referring now to FIG. 7, the various outputs shown in FIG. 6 are shown organized for rendering to a user interface. As shown, the outputs may be grouped into various categories (e.g., pages). For example, FIG. 7 shows a planning portion 700, an insights portion 705, a configuration portion 710, and a data portion 715. In various embodiments, each grouping may be an individual rendering (e.g., a user interface may include tabs that allows a user to move between the different groupings). Alternatively, one or more portions may be rendered together (e.g., the planning portion 700 may be provided on a part of the user interface and the insights portion 705 may be provided on another part of the user interface).

The various inputs and/or outputs of FIG. 6 may be placed into a given portion. For example, the planning portion 700 may include the task(s) 610 and the plan(s) 611, and the insights portion 705 may include the insight(s) 621 and the claim(s) 620. Additional data may also be included independent of the workflows discussed in reference to FIG. 6. For example, the configuration portion 710 may include the onboarding features 720, such as objectives.

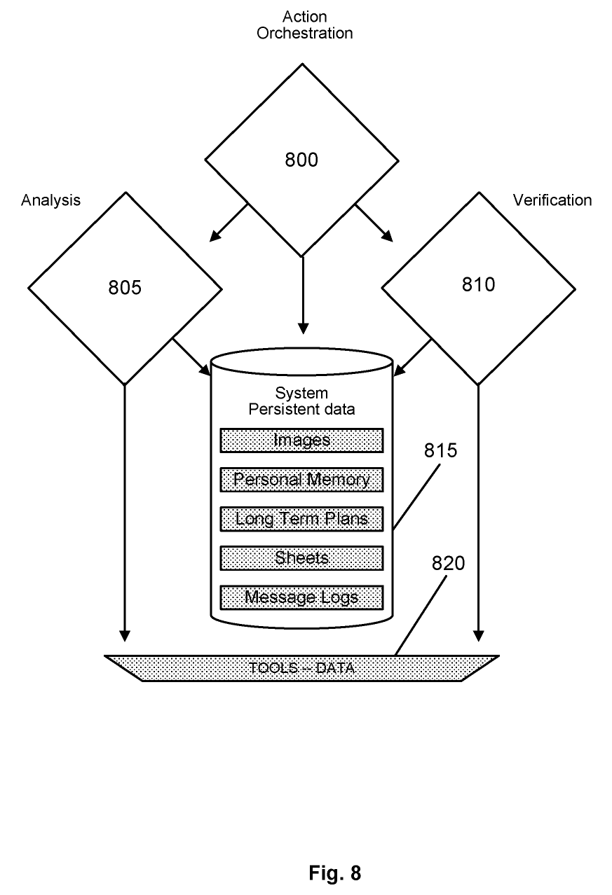

Referring now to FIG. 8, the data processing, generating, and/or storing process is shown. As discussed, the system may receive data, process data, and/or output data in various forms. As such, the system generates large amount of data that may be used in future operations. As shown in FIG. 8, data may be obtained from action orchestration 800 (e.g., the data received from data warehouse(s)/platform(s) 205), data analysis 805 (e.g., data generated based on analysis of the data received from data warehouse(s)/platform(s) 205), and/or verification 810 (e.g., data generated by verifying the data generated via the data analysis).

As such, the different types of data may be stored on the data analysis system 175 (e.g., stored as system persistent data 815). The system persistent data 815 may be stored on a memory device, such as the memory device(s) 268 of the data analysis server(s) 151. The system persistent data 815 may be used in various future operations (e.g., tools/data analysis 820). Example data stored as system persistent data 815 includes insights, personal memory for individual agent device(s), long term plans, sheets relating to previous insights and/or interactions, message logs (e.g., generated via chat), and/or the like. Any of the data stored as system persistent data 815 may be considered a “previous plan” and may be used to determine future plans and/or insights. The data analysis system 175 (e.g., a machine learning model of the data analysis system) may be trained via the system persistent data 815.

FIGS. 9-16 illustrate various different renderings via a user interface (e.g., a user interface of the computing device(s) 152). The renderings illustrate example ways in which the insights generated may be provided to users. In various embodiments, a user associated with an entity may have access to a portal with the various pages shown in FIGS. 9-16.

Referring now to FIG. 9, an example user dashboard 900 is shown with data analysis completed by the system. The dashboard 900 may include insights (e.g., identified anomalies, detected trends, recommended actions, and/or the like). As shown, the insights may be in word form. Various embodiments may display the data analysis in various forms, such as numerical, alphanumerical, graphical, and/or the like. The dashboard 900 may include additional information for the user, such as notifications (e.g., new insights).

The dashboard 900 may include a headline 905 (“Jeans Sales Surge 29%: Order 6,000 Units to Meet Holiday Demand”), a date of the data analysis 910, a summary 915, and one or more recommended actions 920. The headline 905 may be a succinct overview of the data analysis (e.g., trends, recommendations, etc.). The summary 915 may include a quick overview of the data analysis. Additional analysis may be accessible (e.g., via a report that is viewable or otherwise downloadable).

The recommended actions 920 may include multiple options (e.g., the dashboard 900 include two recommendations). The recommended actions 920 may also include projections based on the recommended action. For example, the recommended actions include pausing the current sale, which would create $53,599 in additional projected sales or ordering 6,000 more jeans to meet the demand, which would create $240,000 in additional projected sales. In various embodiments, the system may be capable of at least partially carrying out the recommended actions (e.g., the system may be capable of ordering more jeans in an instance in which the option of ordering 6,000 jeans is selected). Additionally or alternatively, the system may provide information via the user interface for completing the recommended actions (e.g., the system may provide a user with the phone number for the vendor to purchase the additional jeans).

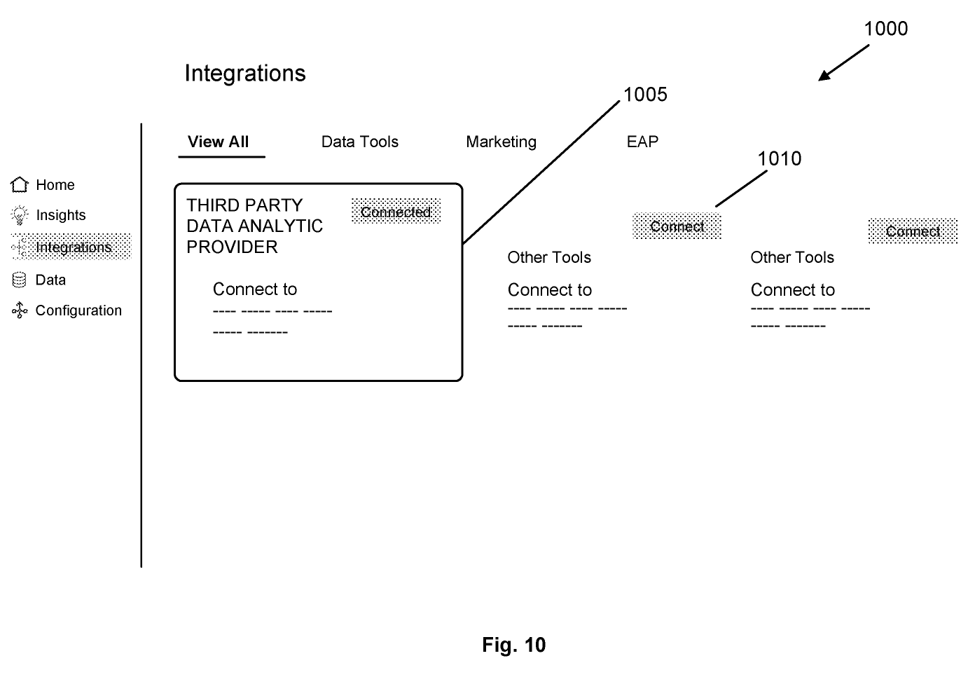

Referring now to FIG. 10, an integrations page 1000 of the user interface is shown. The different data platform(s)/warehouse(s) and/or any additional tools used may be shown in the integrations area of the user interface. The integrations page 1000 may also allow for the connection of additional tools and/or management of the setting for various tools. As shown in FIG. 10, a third party analytic provider 1005 may be connected. Example third party analytic providers include Looker by Google. Selecting the connected tools (e.g., third party analytic provider 1005) may allow the user to update settings relating to the given provider). Additional tools may be shown on the integrations page and/or blank slots (e.g., slot 1010) may be shown to connect other tools. For example, a user may select the slot 1010 and select other tools to be connected for integration.

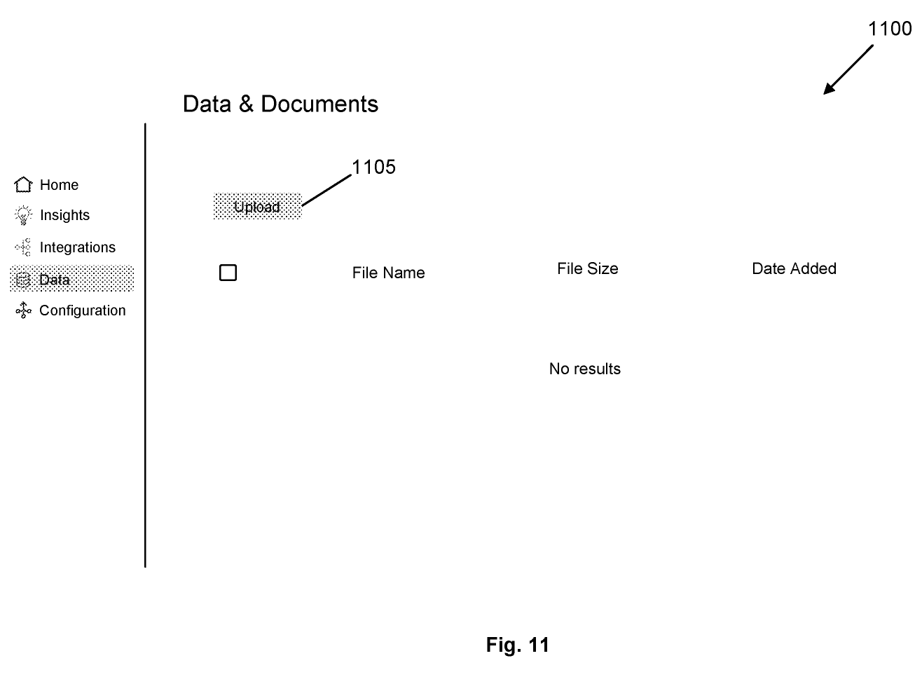

Referring now to FIG. 11, a data and documents page 1100 is provided. The data and documents page 1100 allows a user to upload or otherwise input data into the system. For example, the data and documents page 1100 may include an upload engagement icon 1105, which upon engagement may allow the user to upload documents and/or data. The documents and/or data uploaded may be relating to the data being processed in the system (e.g., the documents and/or data may be used to train the models analyzing the data from the platform(s) and/or warehouse(s)). As such, the system may parse and/or otherwise process uploaded documents and/or data for use as discussed herein. Any documents and/or data uploaded by a user may be rendered on the data and documents page 1100. The data uploaded may also be used to detect anomalies, identify trends, and/or provide recommended actions, as discussed herein.

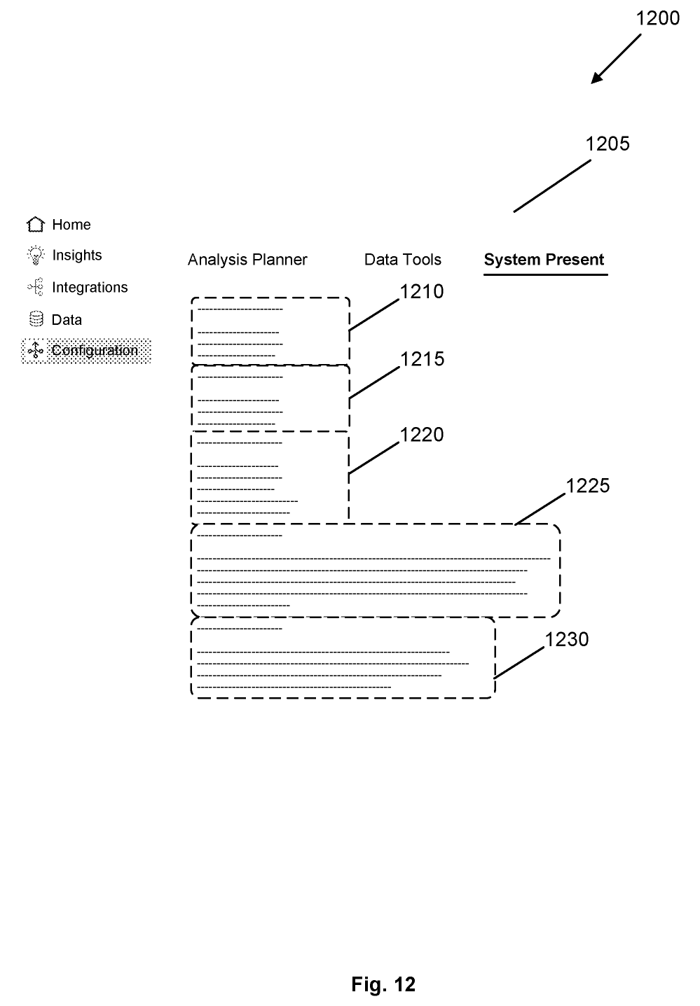

Referring now to FIG. 12, a configuration page 1200 is provided. The configuration page 1200 may include various information used by the system to determine the claims and/or insights discussed herein. For example, the system prompt 1205 may include information about the entity 1210 (e.g., company, industry, description, size), key objectives 1215 (e.g., reduce customer churn, optimize marketing spend, accelerate referral program), important metrics 1220 (e.g., customer satisfaction score, customer churn rate, revenue growth, average resolution time, first contact resolution rate, customer lifetime value specific), challenges 1225 (e.g., limited analysis of relationships between metrics, lack of predictive analysis for revenue growth, underutilization of customer lifetime metric, difficulty in quickly turning data into actionable insights), and/or areas for analysis 1230 (e.g., deeper analysis of correlations between customer service metrics and satisfaction scores, identifying specific drivers of revenue growth, developing strategies based on customer lifetime value). The configuration may be used by the data analysis system 175 to teach a machine learning model to analyze the data as discussed herein.

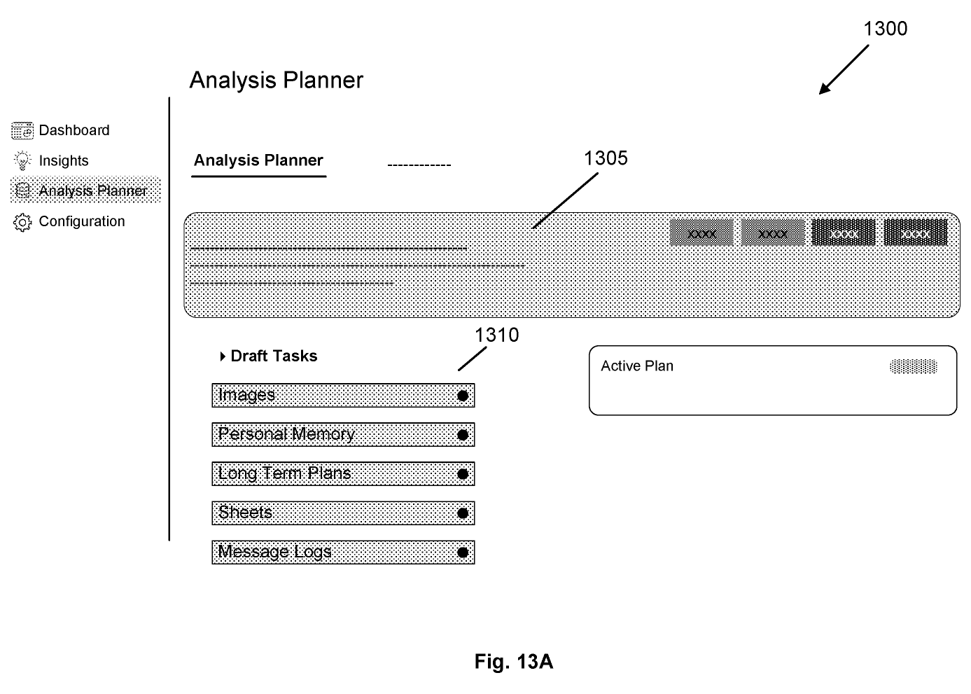

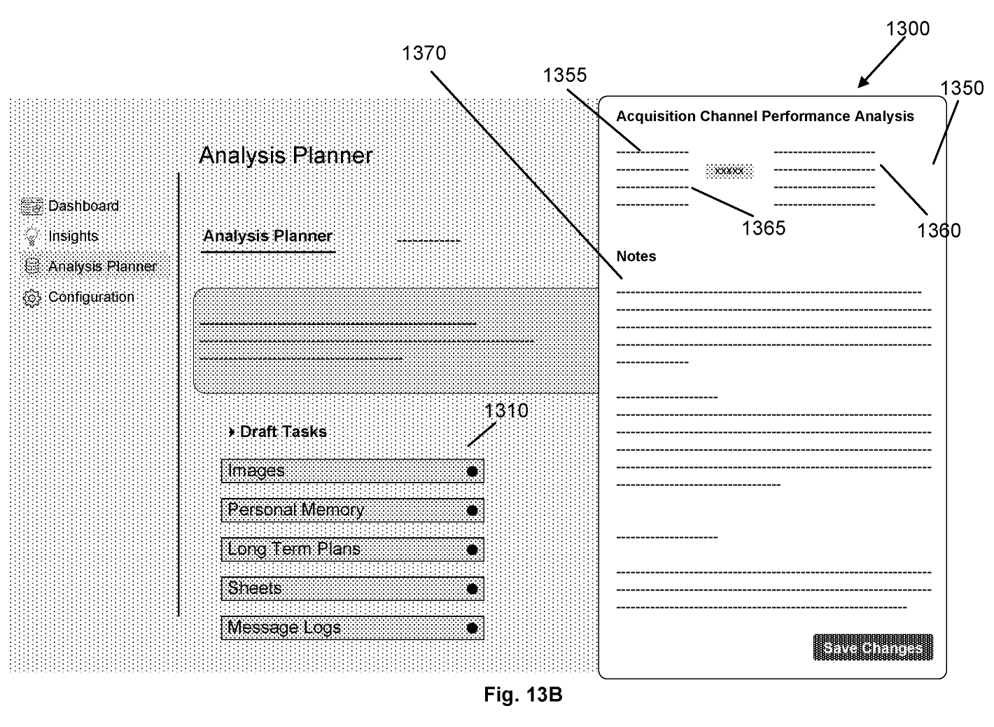

Referring now to FIGS. 13A and 13B, an analysis planner page 1300 is shown. The analysis planner page 1300 may provide information relating to the data processed (e.g., overview of the plan used to determine the insights, tasks and/or draft tasks for the plan, etc.). The analysis planner page 1300 may include a plan overview 1305. The plan overview 1305 may detail the plan and details therein. For example, the plan may be relating to optimizing inventory and the plan overview may give information relating to the plan. Draft tasks 1310 and/or already confirmed tasks may also be rendered on an analysis planner page 1300.

The plan and plan overview may be generated based on the configuration information (e.g., shown in the configuration page 1200 of FIG. 12). The configuration information may be used to determine the plan. The draft tasks may be generated automatically. Draft tasks may be partially generic (e.g., a cost-benefit analysis may be included as a draft task for each plan). Additionally or alternatively, draft tasks may be based specifically on the configuration information (e.g., a more revenue focused entity may have more tasks relating to revenue). The system may determine the task(s) used to determine insight(s) using the draft tasks.

FIG. 13B includes an analysis task portion 1350. The analysis task portion 1350 may include information relating to a task, such as the priority 1355, the status 1360, related insights 1365, and/or notes bincluding relevant context, data fields, process, and/or the like. The analysis task portion 1350 may include the information used by the system to carry out the operations herein. For example, the task may be related to a specific workflow and the information in the analysis task portion 1350 may be used to carry out the given workflow (e.g., the acquisition channel performance analysis may be completed using the information in the analysis task portion 1350). In various embodiments, the information in the analysis task portion 1350 may be editable (e.g., by the user using the portal shown in FIGS. 9-16).

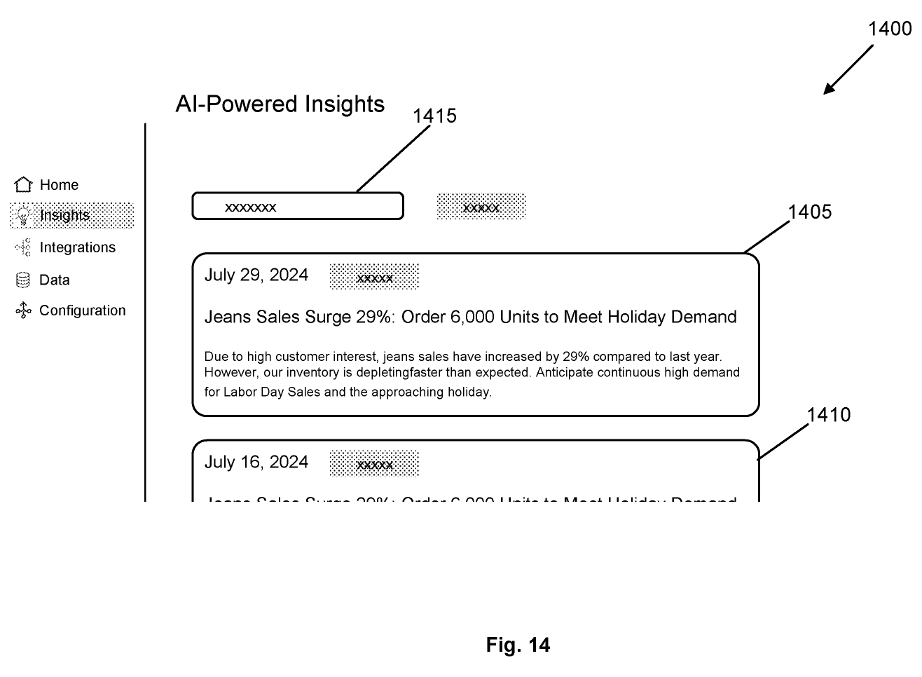

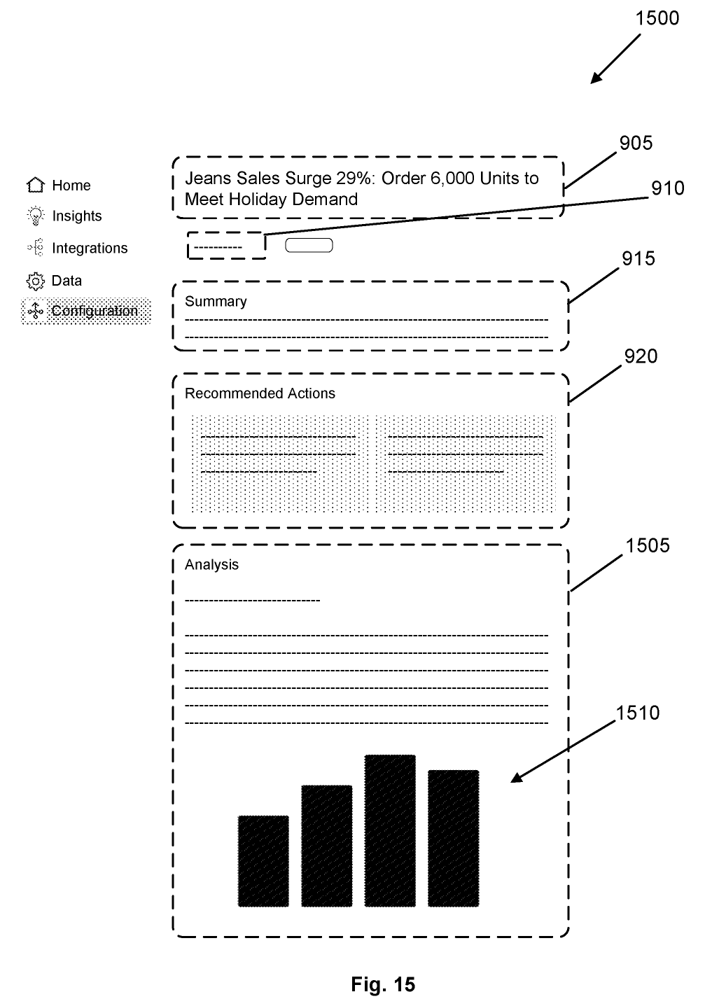

Referring now to FIG. 14, an insights page 1400 is provided. The insights page 1400 may include one or more insights generated using the system discussed herein. For example, the insight shown and discussed in reference to FIG. 9. The insights may include a priority level (e.g., insight 1405 is a high priority, while insight 1410 is a low priority). The insights may be sorted by priority, date, and/or the like. In various embodiments, the insights may be searchable (e.g., via search bar 1415). The insights may be selectable (e.g., selecting an insight may move the user interface to an individual insight page 1500 shown in FIG. 15).

Referring now to FIG. 15, the individual insight page 1500 may include some or all of the information on the dashboard 900 (e.g., headline 905, date of data analysis 910, summary 915, and/or recommended action(s) 920). Additionally or alternatively, more analysis may be provided (e.g., analysis 1505). The analysis 1505 may include information that was used to generate the insight (e.g., the number of outstanding orders, the amount of units in stock, the estimated arrival of inventory, etc.). The analysis 1505 may be alphanumerical and/or graphical (e.g., graph 1510 illustrates inventory and projected demand).

As shown in FIG. 16, a chat page 1600 may be provided. The chat page 1600 may be part of an existing page (e.g., the chat page 1600 is part of the individual insight page 1500 of FIG. 15). In various embodiments, a page on the user interface may have a chat icon or selectable wording, which upon selection may render the chat box 1605. The chat box 1605 may allow a user to input questions. In various embodiments, the system may be capable of responding to the input automatically. For example, the system may receive the user input and determine a potential response to the input.

The response to a user input may be based on the user input (e.g., a user may ask a specific question), the page on which the user is currently located (e.g., the user input may be related to the specific page, such as the individual insight page), and/or the like. In various embodiments, the data analyzed as discussed herein may be used to generate the response to the user input. The response to the user input may be in conversational form (e.g., simulating a human chat agent). In various embodiments, human chat agents may be notified in an instance in which a response is not determined (e.g., the system does not recognize what a user is asking) and/or in an instance in which the response was not satisfactory (e.g., a user may indicate that the response did not solve the intended issue).

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The devices, modules, and other functional units described in this disclosure can be implemented by hardware, or software, or a combination of hardware and software. In some embodiments, functions described as being implemented in hardware may instead be implemented in software (e.g., a computer program product) or a combination of hardware and software. Likewise, in some embodiments, functions described as being implemented in software may instead be implemented in hardware or a combination of hardware and software. If something is implemented by software, it may be stored in a non-transitory computer-readable media, like the computer-readable media described above. Such software, when executed by a processor, may perform the function of the device, module or other functional unit the software is implementing. The above-described devices, modules, and other functions units may also be combined or may be further divided into a plurality of sub-units.

In some places, reference is made to standards, including standards describing methods of performing various tasks. These standards are revised from time to time, and, unless explicitly stated otherwise, reference to standards in this disclosure refer to the most recent published standard as of the time of filing.

Spatially relative terms, such as “under”, “below”, “lower”, “over”, “upper” and the like, may be used herein for ease of description to describe one element or feature’s relationship to another when the apparatus is right side up.

When a feature is referred to as being “on” another feature, the feature may be directly on the other feature with no intervening features present or it may be indirectly on the other feature with intervening features being present. In contrast, when a feature is referred to as being “directly on” another feature, the feature is directly on the other feature with no intervening features present. It will also be understood that, when a feature is referred to as being “connected”, “attached” or “coupled” to another feature, the feature may be directly connected, attached or coupled to the other feature with no intervening features present or it may be indirectly connected, attached or coupled to the other feature with intervening features being present. In contrast, when a feature is referred to as being “directly connected”, “directly attached” or “directly coupled” to another feature, the feature is directly connected, directly attached, or directly coupled to the other feature with not intervening features present.

The terms “about” and “approximately” shall generally mean an acceptable degree of error or variation for the quantity measured given the nature or precision of the measurements. Typical, exemplary degrees of error or variation are within 20%, preferably within 10%, more preferably within 5%, and still more preferably within 1% of a given value or range of values. Numerical quantities given in this description are approximate unless stated otherwise, meaning that the term “about” or “approximately” can be inferred when not expressly stated.

Ordinal numbers or terms such as “first” and “second” are used only to differentiate an entity or operation from another entity or operation, and do not require or imply any actual relationship or sequence between these entities or operations. Thus, a first feature or element could be termed a second feature or element, and similarly, a second feature or element could be termed a first feature or element without departing from the teachings of the present disclosure. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the terms “or” and “at least one of” encompasses all possible combinations, except where infeasible. For example, if it is stated that a component may include “A or B,” then, unless specifically stated otherwise or infeasible, the component may include “A,” “B,” or “A and B.” As a second example, if it is stated that a component includes “at least one of A, B, or C,” then, unless specifically stated otherwise or infeasible, the component may include “A,” “B,” “C,” “A and B,” “A and C,” “B and C,” or “A, B, and C.” This same construction applies to longer lists (e.g., “may include A, B, C, or D”).

As used herein, the singular forms “a”, “an,” and “the” are intended to include the plural forms as well, unless the context clearly indicates otherwise.

Any statements in this disclosure criticizing or disparaging aspects of the prior art are not intended to indicate that what is claimed excludes any of those criticized or disparaged aspects of the prior art.

Any given element or step of the embodiments disclosed above may be embodied in a single element or step or may be embodied in multiple elements or steps. Moreover, any given element or step of the embodiments disclosed above may be combined and embodied in single element or step or may be combined and embodied in multiple elements or steps.

The sequence of steps shown in the various figures are only for illustrative purposes and do not necessarily indicate that embodiments of the present disclosure are limited to any particular sequence of steps. As such, steps performed by various embodiments of the present disclosure can be performed in a different order while implementing the same method.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A system for detecting anomalies across data infrastructure, comprising:
at least one non-transitory storage device; and
at least one processing device coupled to the at least one non-transitory storage device,
wherein the at least one processing device is configured to:
cause a transmission of a request for data associated with an entity, wherein the transmission is to at least one of a data platform or a data warehouse and includes credentials to access the data associated with the entity, wherein the at least one of the data platform or the data warehouse comprises data associated with the entity;
receive the data associated with the entity from the at least one of the data platform or the data warehouse;
based on the data associated with the entity, generate at least one insight associated with the entity, wherein the at least one insight comprises at least one recommended action for the entity; and
cause a rendering of the at least one insight to a user interface of a computing device.

2. The system of claim 1, wherein the at least one processing device is configured to generate a summary of the at least one insight, wherein the summary is rendered to the user interface.

3. The system of claim 1, wherein the at least one insight is associated with a detected anomaly or an identified trend.

4. The system of claim 1, wherein the at least one insight is determined based on a previous plan associated with the entity, wherein the previous plan comprises at least one previous insight.

5. The system of claim 1, wherein the at least one of the data platform or the data warehouse is controlled by a third party entity, wherein the data associated with the entity is determined via the request.

6. The system of claim 1, wherein the at least one processing device is configured to generate the at least one insight via one or more workflows.

7. The system of claim 1, wherein a first agent device is in communication with a first data platform or data warehouse of the at least one of the data platform or the data warehouse and a second agent device is in communication with a second data platform or data warehouse of the at least one of the data platform or the data warehouse.

8. The system of claim 7, wherein the first agent device determines a first insight of the at least one insight and the second agent device determines a second insight of the at least one insight.

9. The system of claim 8, wherein the first agent device and the second agent device are distinct computing devices.

10. The system of claim 7, wherein at least one of the first agent device or the second agent device is automated.

11. A method for detecting anomalies across data infrastructure, the method comprising:
causing a transmission of a request for data associated with an entity, wherein the transmission is to at least one of a data platform or a data warehouse and includes credentials to access the data associated with the entity, wherein the at least one of the data platform or the data warehouse comprises data associated with the entity;
receiving the data associated with the entity from the at least one of the data platform or the data warehouse;
based on the data associated with the entity, generating at least one insight associated with the entity, wherein the at least one insight comprises at least one recommended action for the entity; and
causing a rendering of the at least one insight to a user interface of a computing device.

12. The method of claim 11, further comprising generating a summary of the at least one insight, wherein the summary is rendered to the user interface.

13. The method of claim 11, wherein the at least one insight is associated with a detected anomaly or an identified trend.

14. The method of claim 11, wherein the at least one insight is determined based on a previous plan associated with the entity, wherein the previous plan comprises at least one previous insight.

15. The method of claim 11, wherein the at least one of the data platform or the data warehouse is controlled by a third party entity, wherein the data associated with the entity is determined via the request.

16. The method of claim 11, further comprising generating the at least one insight via one or more workflows.

17. The method of claim 11, wherein a first agent device is in communication with a first data platform or data warehouse of the at least one of the data platform or the data warehouse and a second agent device is in communication with a second data platform or data warehouse of the at least one of the data platform or the data warehouse.

18. The method of claim 17, wherein the first agent device determines a first insight of the at least one insight and the second agent device determines a second insight of the at least one insight.

19. The method of claim 18, wherein the first agent device and the second agent device are distinct computing devices.

20. The method of claim 17, wherein at least one of the first agent device or the second agent device is automated.
